(19) United States
(12) Patent Application Publication
(10) Pub. No.: US 2022/0101087 A1
(43) Pub. Date: Mar. 31, 2022

(54) MULTI-MODAL REPRESENTATION BASED EVENT LOCALIZATION

(71) Applicant: QUALCOMM Incorporated, San Diego, CA (US)

(72) Inventors: Juntae LEE, Seoul (KR); Mihir JAIN, Amsterdam (NL); Sungrack YUN, Seongnam (KR); Hyoungwoo PARK, Seoul (KR); Kyu Woong HWANG, Daejeon (KR)

(21) Appl. No.: 17/405,879

(22) Filed: Aug. 18, 2021

Related U.S. Application Data
(60) Provisional application No. 63/085,764, filed on Sep. 30, 2020.

(51) Int. Cl. G06N 3/04; G06K 9/62

(52) U.S. Cl. CPC G06N 3/04; G06K 9/6293; G06K 9/6298; G06K 9/623

(57) ABSTRACT

A method performed by an artificial neural network (ANN) includes determining, at a first stage of a multi-stage cross-attention model of the ANN, a first cross-correlation between a first representation of each modality of a number of modalities associated with a sequence of inputs. The method still further includes determining, at each second stage of one or more second stages of the multi-stage cross-attention model, a second cross-correlation between first attended representations of each modality. The method also includes generating a concatenated feature representation associated with a final second stage of the one or more second stages based on the second cross-correlation associated with the final second stage, the first attended representation of each modality, and the first representation of each modality. The method further includes determining a probability distribution between a set of background actions and a set of foreground actions from the concatenated feature representation. The method still further includes localizing an action in the sequence of inputs based on the probability distribution.

### CROSS-REFERENCE TO RELATED APPLICATION

The present application claims the benefit of U.S. Provisional Patent Application No. 63/085,764, filed on Sep. 30, 2020, and titled “LEVERAGING OF AUDIO INFORMATION FOR ACTION LOCALIZATION,” the disclosure of which is expressly incorporated by reference in its entirety.

### BACKGROUND

### Field

Aspects of the present disclosure generally relate to localizing events based on representations associated with multiple modalities.

### Background

Artificial neural networks may comprise interconnected groups of artificial neurons (e.g., neuron models). The artificial neural network may be a computational device or represented as a method to be performed by a computational device. Convolutional neural networks, such as deep convolutional neural networks, are a type of feed-forward artificial neural network. Convolutional neural networks may include layers of neurons that may be configured in a tiled receptive field.

Convolutional neural networks are used in various technologies, such as autonomous driving, Internet of Things (IoT) devices, and action localization. In conventional systems, an action (e.g., an event) may be localized based on visual data. In some videos, there may be little, to no, visual change in the visual data over time. Therefore, it may be difficult to localize the action based only on the visual data. It may be desirable to use representations from multiple modalities to improve action localization.

### SUMMARY

In one aspect of the present disclosure, a method performed by an artificial neural network (ANN) includes determining, at a first stage of a multi-stage cross-attention model of the ANN, a first cross-correlation between a first representation of each modality of a number of modalities associated with a sequence of inputs. The method still further includes determining, at each second stage of one or more second stages of the multi-stage cross-attention model, a second cross-correlation between first attended representations of each modality. A first attended representation of a first modality of the number of modalities may be based on the first cross-correlation and the first representation of the first modality. Additionally, the first attended representation of a second modality of the number of modalities may be based on the first cross-correlation and the first representation of the second modality. The method also includes generating a concatenated feature representation associated with a final second stage of the one or more second stages based on the second cross-correlation associated with the final second stage, the first attended representation of each modality, and the first representation of each modality. The method further includes determining a probability distribution between a set of background actions and a set of foreground actions from the concatenated feature representation. The method still further includes localizing an action in the sequence of inputs based on the probability distribution.

Another aspect of the present disclosure is directed to an ANN including means for determining, at a first stage of a multi-stage cross-attention model of the ANN, a first cross-correlation between a first representation of each modality of a number of modalities associated with a sequence of inputs. The apparatus still further includes means for determining, at each second stage of one or more second stages of the multi-stage cross-attention model, a second cross-correlation between first attended representations of each modality. A first attended representation of a first modality of the number of modalities may be based on the first cross-correlation and the first representation of the first modality. Additionally, the first attended representation of a second modality of the number of modalities may be based on the first cross-correlation and the first representation of the second modality. The apparatus also includes means for generating a concatenated feature representation associated with a final second stage of the one or more second stages based on the second cross-correlation associated with the final second stage, the first attended representation of each modality, and the first representation of each modality. The apparatus further includes means for determining a probability distribution between a set of background actions and a set of foreground actions from the concatenated feature representation. The apparatus still further includes means for localizing an action in the sequence of inputs based on the probability distribution.

In another aspect of the present disclosure, a non-transitory computer-readable medium with non-transitory program code recorded thereon is disclosed. The program code is executed by a processor and includes program code to determine, at a first stage of a multi-stage cross-attention model of an ANN, a first cross-correlation between a first representation of each modality of a number of modalities associated with a sequence of inputs. The program code still further includes program code to determine, at each second stage of one or more second stages of the multi-stage cross-attention model, a second cross-correlation between first attended representations of each modality. A first attended representation of a first modality of the number of modalities may be based on the first cross-correlation and the first representation of the first modality. Additionally, the first attended representation of a second modality of the number of modalities may be based on the first cross-correlation and the first representation of the second modality. The program code also includes program code to generate a concatenated feature representation associated with a final second stage of the one or more second stages based on the second cross-correlation associated with the final second stage, the first attended representation of each modality, and the first representation of each modality. The program code further includes program code to determine a probability distribution between a set of background actions and a set of foreground actions from the concatenated feature representation. The program code still further includes program code to localize an action in the sequence of inputs based on the probability distribution.

Another aspect of the present disclosure is directed to ANN comprising a processor, a memory coupled with the processor, and instructions stored in the memory and operable, when executed by the processor, to cause the apparatus to determine, at a first stage of a multi-stage cross-attention model of the ANN, a first cross-correlation between a first representation of each modality of a number of modalities associated with a sequence of inputs. Execution of the instructions further cause the ANN to determine, at each second stage of one or more second stages of the multi-stage cross-attention model, a second cross-correlation between first attended representations of each modality. A first attended representation of a first modality of the number of modalities may be based on the first cross-correlation and the first representation of the first modality. Additionally, the first attended representation of a second modality of the number of modalities may be based on the first cross-correlation and the first representation of the second modality. Execution of the instructions also cause the ANN to generate a concatenated feature representation associated with a final second stage of the one or more second stages based on the second cross-correlation associated with the final second stage, the first attended representation of each modality, and the first representation of each modality. Execution of the instructions still further cause the ANN to determine a probability distribution between a set of background actions and a set of foreground actions from the concatenated feature representation. Execution of the instructions further cause the ANN to localize an action in the sequence of inputs based on the probability distribution.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4A is a block diagram illustrating an example of cross-model architecture, in accordance with aspects of the present disclosure.

FIG. 4B is a block diagram illustrating an example of cross-model architecture with gating controllers, in accordance with aspects of the present disclosure.

FIG. 5 illustrates a flow diagram for a method in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described above, in conventional systems, an action (e.g., an event) may be localized based on visual data. In some sequences of frames, there may be little, to no, visual change in the visual data over time. In contrast, an audio sequence associated with the sequence of frames may change from one frame to the next. For ease of explanation, a sequence of frames may also be referred to as a video. For example, a player may shout “hit the ball” at one frame, and one or more other frames may include a sound of a ball being hit as well as other volleyball related sounds. Therefore, it may be difficult to localize the action based only on the visual data. It may be desirable to use representations from multiple modalities to improve action localization.

Some conventional systems combine audio data with visual data to localize action in short video clips including a single action. Still, these conventional systems may fail to localize multiple actions and may also fail to localize action in an extended sequence of frames. It may be desirable to correlate audio data with video data to localize action in a long video input stream.

In some examples, audio data may be an example of a modality and video data may be an example of another modality. Still, aspects of the present disclosure are not limited to correlating audio data with video data. Aspects of the present disclosure also contemplate correlating other types of modalities received from one or more sensor data streams, such as, but not limited to LIDAR, RADAR, motion, or gyroscopic. Various aspects of the present disclosure are directed to a cross-model architecture that progressively propagates and fuses multiple modalities. In some aspects, a multi-stage cross-attention mechanism fuses audio and visual features into coordinated audio-visual features. In one configuration, for each video frame, an open-max classifier predicts scores for action and background classes. The open-max classifier may include parallel branches for action classification and foreground reliability estimation. In this configuration, the open-max classifier addresses the ambiguity of backgrounds. Additionally, a pseudo loss is specified for robust action localization with weak supervision. The pseudo loss considers the temporal continuity of the predicted label.

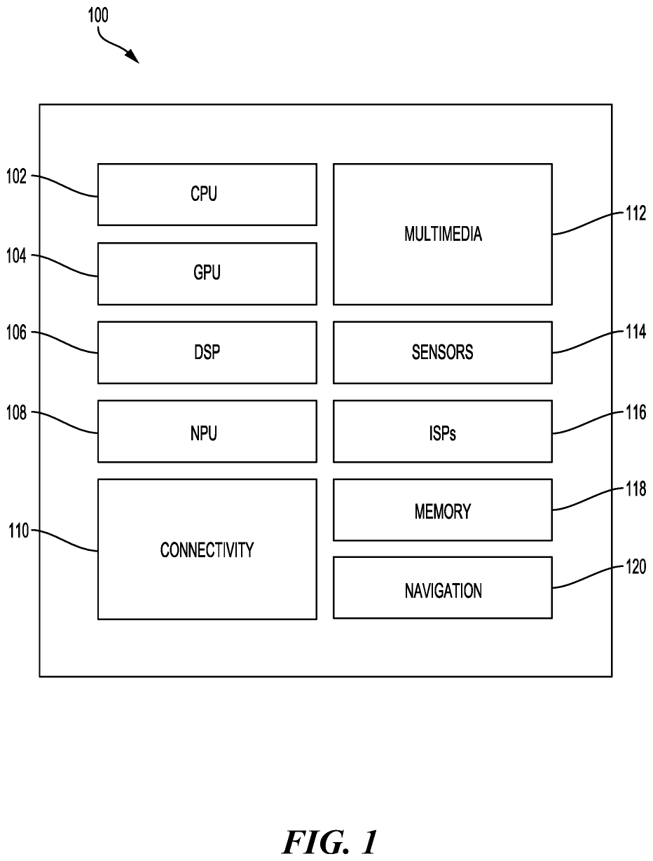

FIG. 1 illustrates an example implementation of a system-on-a-chip (SOC) 100, which may include a central processing unit (CPU) 102 or a multi-core CPU configured for using audio and video data for action localization in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may comprise code to determine a first cross-correlation between a first audio representation and a first video representation of a sequence of frames; determine one or more second cross-correlations based on the first cross-correlation, the first audio representation, and the first video representation; generate a concatenated feature representation based on the one or more second cross-correlations, the first cross-correlation, the first audio representation, and the first video representation; determine a probability distribution between a set of background actions and a set of foreground actions from the concatenated feature representation; and localize an action in the sequence of frames based on the probability distribution.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

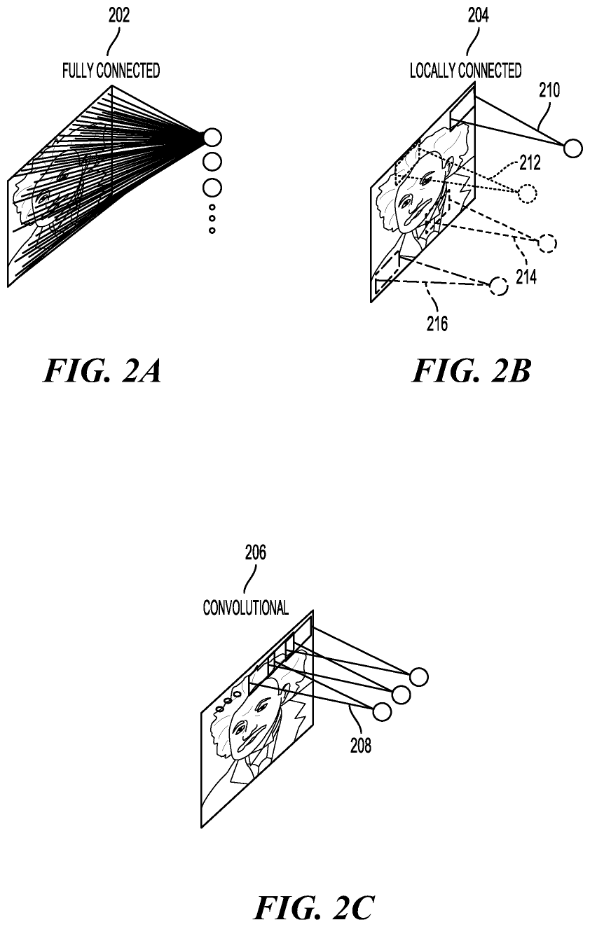

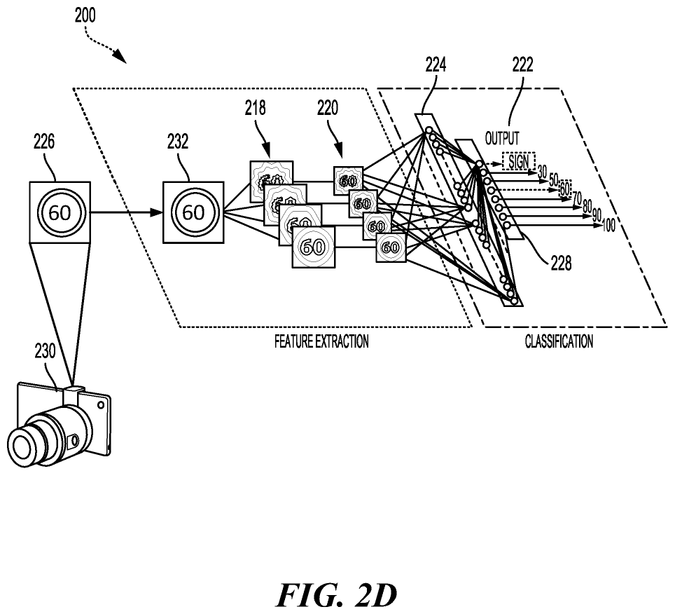

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 226) and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

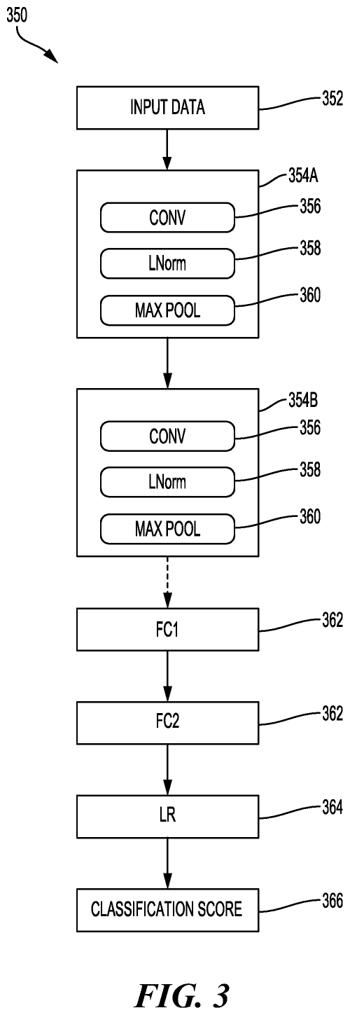

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data, including a feature from a set of features.

As discussed above, in some cases, it may be difficult to localize (e.g., identify) an action based only on visual data. As an example, based only on visual data, an action localization system may not accurately determine an action associated with a person speaking into a microphone. In this example, the action may be singing, lecturing, performing stand-up comedy, or another type of action. Thus, in such examples, without audio data, an action localization system may fail to accurately determine the action associated with the person speaking into the microphone. As another example, based only on visual data, an action localization system may not accurately determine an action associated with a group of people standing together with their arms in the air. In this example, the action may be protesting, cheering, or another type of action. Thus, in such examples, without audio data, an action localization system may fail to accurately determine the action associated with the group of people. Additionally, or alternatively, in some examples, audio data may identify a start and an end of an activity, such as a billiard shot. Identifying a start and an end of an activity may further improve action localization accuracy.

In some aspects, a cross-model architecture may be implemented for an action localization model. The cross-model architecture may localize an action sequence based on features of multiple modalities. Although multiple modalities may provide more information in comparison to information provided by a single modality, modality-specific information may be reduced when multiple modalities are fused. Therefore, some aspects of the present disclosure implement a multi-stage cross-attention mechanism where features are separately learned for each modality under constraints from the other modality. In such aspects, the learned features for each modality encode inter-modal information, while preserving intra-modal characteristics.

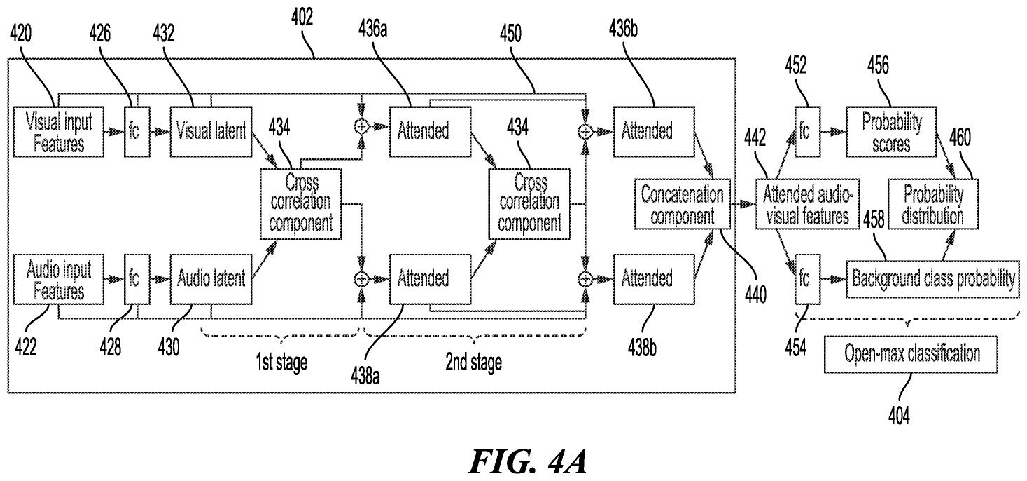

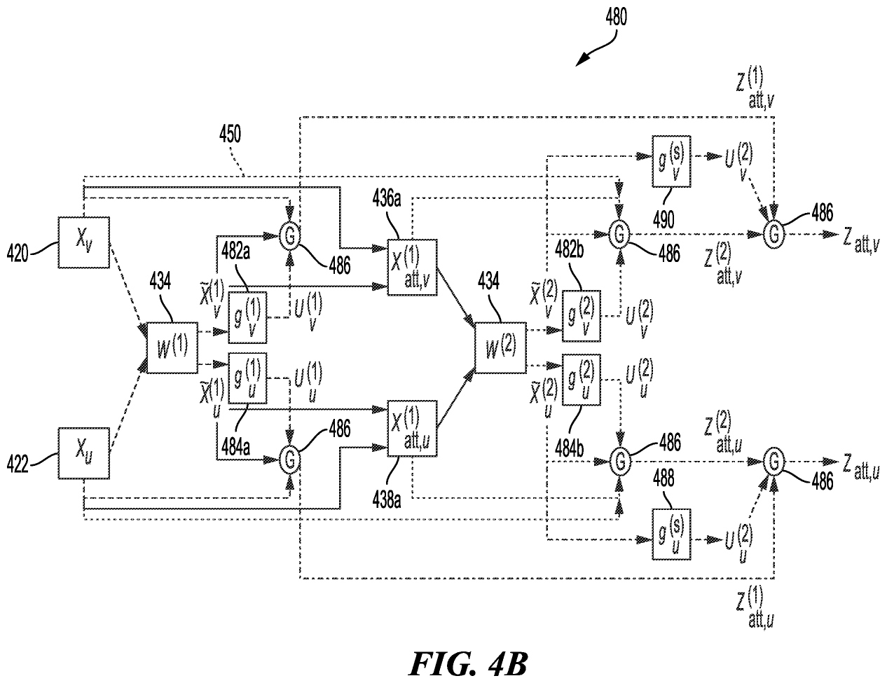

FIG. 4A is a block diagram illustrating an example of cross-model architecture 400, in accordance with aspects of the present disclosure. In such aspects, the cross-model architecture 400 progressively propagates and fuses two modalities. As shown in FIG. 4A, the cross-model architecture 400 includes a multi-stage cross-attention component 402 that fuses features from two different inputs, such as a visual input 420 and an audio input 422. The cross-model architecture 400 also includes an open-max classifier component 404 that predicts scores for action and background classes. In some examples, during training, a pseudo loss may be specified for the cross-model architecture 400. The training may be weakly supervised training to improve a robustness of the action localization. The pseudo loss may consider a temporal continuity of a predicted localization.

As shown in FIG. 4A, each input 420 and 422 may be generated based on uniformly sampled non-overlapping snippets from a video. Each snippet may be an example of a frame. As an example, the audio input features 422 may be represented as U=(u^{l})ᵢ₌₁^{L}∈ [symbol] ^{d}^{ᵤ}^{×L}, where u^{l} represent a dimensional audio feature dᵤ of a frame l and L represents a total number of non-overlapping frames uniformly sampled from the video. Likewise, the visual input features 420 may be represented as V=(v^{l})ₗ₌₁^{L}∈ [symbol] ^{d}^{ᵥ}^{×L}, where v^{l} represents a dimensional visual feature dᵥ of a frame l. A video-level label may be represented as c∈{0, 1, . . . , C}, where C is a number of action classes and 0 represents a background class. In some aspects, the cross-model architecture 400 may categorize each frame l into C+1 classes, thereby localizing an action in the sequence of frames L based on the audio input features 422 and visual input features 420.

As shown in FIG. 4A, the features of each input 420 and 422 may be received at modality-specific fully-connected (fc) layers 426 and 428 to encode features of the respective inputs 420 and 422. The encoded features may be referred to as latent representations 430 and 432. As an example, the audio input features 422 may be encoded to an audio latent representation 430 and the visual input features 420 may be encoded to a visual latent representation 432. The audio latent representation 430 may be represented as Xᵤ=(xᵤ^{l})ₗ₌₁^{L} and the visual latent representation 432 may be represented as Xᵥ=(xᵤ^{l})ₗ₌₁^{L}, where xᵤ^{l} and xᵥ^{l} are in [symbol] ^{d}^{ₓ}, dₓ represents a dimensional vector space, and [symbol] represents a real value. As shown in FIG. 4A, a cross-correlation matrix may be determined at a cross-correlation component 434 based on the audio latent representation 430 and the visual latent representation 432 to measure inter-modal relevance. To reduce the gap of a heterogeneity between the two modalities, a learnable weight matrix may be used when determining the cross-correlation matrix. In some aspects, the cross-correlation component 434 may determine the cross-correlation matrix as follows:

Λ=Xᵤ^{T}WXᵥ, (1)

where Λ represents the cross-correlation matrix, T represents a transpose operator, and W represents the weight matrix. In some examples, the weight matrix may be a learnable parameter. In Equation 1, Λ∈ [symbol] ^{L×L} and W∈ [symbol] ^{d}^{ₓ}^{×d}^{ₓ}. In some implementations, the visual latent representation 432 and audio latent representation 430 associated with each frame may be normalized, such as l₂-normalized, before computing the cross-correlation matrix.

In some aspects, a relevancy between audio features and video features associated with a frame may be determined based on a correlation coefficient associated with the frame in the cross-correlation matrix. For example, a high correlation coefficient may be indicative of a high relevancy between audio features and video features associated with a frame. Specifically, the lth column of the cross-correlation matrix may indicate a correlation coefficient of the visual latent representation 432 associated with a frame l to the audio feature of each frame of the L frames. Based on the correlation coefficient (e.g., the relevancy), cross-attention weights may be generated based on a column-wise soft-max of the cross-correlation matrix (Λ) and a transpose of the cross-correlation matrix (Λ^{T}). Then, for each modality, the cross-correlation component 434 may use respective cross-attention weights to re-weigh the features associated with the L frames to obtain attention-weighted features. In some examples, the attention-weighted features increase a distinctiveness of the features given the other modality. In some implementations, the cross-correlation component 434 may determine the attention-weighted features as follows:

\tilde{X}ᵤ=XᵤAᵤ, and (3)

\tilde{X}ᵥ=XᵥAᵥ, (4)

where Aᵤ and Aᵥ represent an audio cross-attention weight and a visual cross-attention weight, respectively, and \tilde{X}ᵤ and \tilde{X}ᵥ represent attention-weighted audio features and attention-weighted visual features, respectively. Specifically, Aᵤ is a column-wise soft-max of the cross-correlation matrix (Λ) and Aᵥ is a column-wise soft-max of Λ^{T}. In the example of FIG. 4A, at each stage of the multi-stage cross-attention component, the cross-correlation component 434 outputs the attention-weighted audio features 436a or 436b and attention-weighted visual features 438a or 438b. The attention-weighted audio features 436a output from the cross-correlation component 434 at the first stage may be represented as \tilde{X}ᵤ⁽¹⁾ and the attention-weighted audio features 436b output from the cross-correlation component 434 at the second stage may be represented as \tilde{X}ᵤ⁽²⁾. Additionally, the attention-weighted visual features 438a output from the cross-correlation component 434 at the first stage may be represented as \tilde{X}ᵥ⁽¹⁾ the attention-weighted visual features 438b output from the cross-correlation component 434 at the first stage may be represented \tilde{X}ᵥ⁽²⁾.

Additionally, as shown in FIG. 4A, each of the attention-weighted audio features and the attention-weighted visual features may be summed with a respective latent feature. As an example, at each stage t, the visual latent representation 432 (Xᵥ) may be summed with the attention-weighted visual features (\tilde{X}ᵥ^{(t)}) to generate attended visual features (X_{att,v}^{(t)}) (shown as attended visual features 436a and 436b) and the audio latent representation 430 (Xᵤ) may be summed with the attention-weighted audio features (\tilde{X}ᵤ^{(t)}) to generate attended audio features (X_{att,u}^{(t)}) (shown as attended audio features 438a and 438b). In the current disclosure, attended features, such as attend audio features, may be examples of attentioned features. Specifically, the attended audio features and the attended visual features may be determined as follows:

X_{att,uv}^{(t)}=tanh(Σᵢ₌₀^{t-1}X_{att,u}⁽ⁱ⁾+\tilde{X}ᵤ^{(t)}) (5)

X_{att,v}^{(t)}=tanh(Σᵢ=0^{t-1}X_{att,v}⁽ⁱ⁾+\tilde{X}ᵥ^{(t)).} (6)

As shown in Equations 5 and 6, at each stage t (t=1, . . . , tₑ), the attended visual features (X_{att,v}^{(t)}) and the attended audio features (X_{att,u}^{(t)}) are based on a tangent function (tanh(·)) of a sum of a previous attended feature and attention-weighted features associated with the current stage t. In some examples, as described above, an initial attended audio feature 438a (X_{att,u}⁽⁰⁾) is equal to the audio latent representation 430 (Xᵤ) and an initial visual feature 436a (X_{att,v}⁽⁰⁾) is equal to the visual latent representation 432 (Xᵥ). In Equations 5 and 6, tanh(·) represents a hyperbolic tangent activation function. In some implementations, multiple cross-attention stages, such as stage one and stage two of FIG. 4A, may be specified to improve the cross-correlation and improve action location accuracy. Still, the multiple cross-attention stages may suppress one or more modality-specific characteristics. Therefore, in some implementations, skip connections 450 may be used to maintain original modality-specific characteristics. Thus, although not shown in Equations 5 and 6, at each stage t, the attended visual features (X_{att,v}^{(t)}) and the attended audio features (X_{att,u}^{(t)}) may be based on the visual latent representation 432 (Xᵥ) and the audio latent representation 430 (Xᵤ), respectively. Aspects of the present disclosure are not limited to two stages, as shown in FIG. 4A. Other quantities of stages are contemplated.

As shown in FIG. 4A, an output of a final stage (shown as attended audio features 438b and attended visual features 436b) may be concatenated at a concatenation component 440 to generate attended audio-visual features 442. In some aspects, the audio-visual features generated at the concatenation component 440 may be represented as:

Xₐₜₜ=[X_{att,u}^{(t}^{ₑ}⁾;X_{att,v}^{(t}^{ₑ}⁾], (7)

where tₑ represents the final stage of the multiple stages. In the example of FIG. 4A, tₑ is equal to two.

In most cases, video segments may be dichotomized into foreground actions and background actions. Some actions, such as foreground actions, may be closed sets where a domain of an action class is shared in both training data and testing data. In contrast, a background action is an open set. Therefore, it may be difficult to train a background class with all possible examples of unknown objects or situations. As an example, an action localization system may be trained to identify a jumping action. The jumping action may be the same in the training data and the testing data. However, the jumping action may be performed at a seemingly unlimited number of locations, where each location may represent a different background. In this example, it may be difficult to train a background class with all possible examples of locations where the jumping action may be performed. Thus, in this example, a deployed action localization model may encounter background instances that are unseen during a training phase. Such background instances may include one or more unseen background actions. Therefore, to improve action localization, it may be desirable to distinguish background actions from foreground actions. In one configuration, an occurrence of a background class may be inferred (or estimated) from the prediction result of closed action classes.

According to some aspects of the present disclosure, to address the discussed problems associated with the background being an open set, an open-max classifier 404 may be used in the cross-model architecture 400. As shown in the example of FIG. 4A, the open-max classifier 404 may include parallel fully connected layers 452 and 454 for action classification and foreground reliability estimation. In the example of FIG. 4A, the attended audio-visual features 442 (Xₐₜₜ^{l}, where l=1, . . . , L) may be output from the concatenation component 440 to the open-max classifier 404. In this example, the attended audio-visual features 442 may be output on a frame-by-frame basis to the open-max classifier 404. In one configuration, an action classification fully connected layer 452 of the open-max classifier 404 receives the attended audio-visual features 442 for a given frame l based on the output of the final concatenation component 440. In this configuration, the action classification fully connected layer 452 generates a frame-wise activation vector based on receiving the attended audio-visual features 442. The frame-wise activation vector may be converted to probability scores 456 based on a soft-max function. The frame-wise activation vector may be represented as h^{l}=[h^{l} (1), . . . , h^{l}(C)] for C action classes, and the probability scores 456 may be represented as p_{ac}^{l}. Additionally, a background class fully connected layer 454 of the open-max classifier 404 receives the attended audio-visual features 442 for a given frame l based on the output of the final concatenation component 440. In this configuration, a foreground reliability may be determined for each frame l by applying the background class fully connected layer 454 the given frame l and then applying a sigmoid function. The foreground reliability is a probability of a frame l belonging to any action class. A low reliability indicates that no action occurs in the given frame I. Therefore, a background class probability 458 may be the complement of the foreground reliability. In some examples, the background class probability 458 is determined as: p_{bg}^{l}=1−μ^{l}, where μ^{l} represents the foreground reliability. The open-max classifier may output a probability distribution 460 (p^{l}) over the C+1 action classes, including the background and C actions as:

p^{l}=[p_{bg}^{l};μ^{l}p_{ac}^{l}] (8)

In some examples, frames in an action or background segment may convey analogous semantics. Therefore, temporally neighboring frames may have a similar open-max probability distribution because actions or a foreground do not abruptly change over time. In some aspects, different temporal continuity losses may be specified to reduce abrupt changes of actions or foregrounds over time. That is, foreground continuity may be specified to maintain two properties for neighboring frames. A first property may provide class-agnostic similar foreground reliability and the second property may provide consistent open-max probabilities for a target foreground class. In such aspects, the class-agnostic (ag) foreground continuity may be imposed as:

$${μ}_{a g}^{l} = \frac{1}{B + 1} {\sum }_{i = - B / 2}^{B / 2} G ( i ) {μ}^{l - i} , \qquad ( 9 )$$

where G (i) is a Gaussian window of width B+1 to apply temporal smoothing over foreground reliability around an lth frame. In Equation 9, the variable μ represents foreground action reliability. Additionally, in Equation 9, a continuity of the lth frame μ_{ag}^{l} is defined by a moving average of foreground reliability between a center value (μ^{l-i}) and also B/2 values to both a left and a right of the center value (μ^{l-i}). A smoothing effect of a data stream may be obtained based on the moving average. The smoothing effect mitigates abrupt changes in foreground continuity. G(i) may also be referred to as a Gaussian weight. Additionally, the consistent open-max probabilities may be obtained by applying temporal Gaussian smoothing over an open-max probability of a video-level ground-truth action class (ĉ) to obtain class-specific (sp) foreground continuity:

$${μ}_{s p}^{l} = \frac{1}{B + 1} {\sum }_{i = - \frac{B}{2}}^{\frac{B}{2}} G ( i ) {p}^{l - i} ( \hat{c} ) . \qquad ( 10 )$$

In Equation 10, p^{l} represents a probability distribution over C classes. The Equation 10 also determines a moving average in a manner similar based on a center frame and frames to the left and right of the center frame. In some aspects, the foreground continuity loss may be defined as:

[symbol]

_{cont}=1/LΣₗ₌₁^{L}|μ^{l}−μ_{ag}^{l}|+|μ^{l}−μₛₚ^{l}|. (11)

The foreground continuity loss imposes temporal continuity of foreground, and hence also helps in separating the background from the action classes.

In some cases, two modalities may be incompatible for fusing in one or more frames. As an example, an audio modality associated with a set of frames may be background noise that is not related to a visual modality associated with the set of frames. Therefore, in this example, fusing the modalities of the set of frames may reduce an accuracy of an action localization. In some examples, a single frame may provide an optimal multi-modal feature, and other frames may not be necessary. According to some aspects of the present disclosure, a gating controller (e.g., a leaky gate) is specified to adaptively determine when and how to fuse two modalities.

FIG. 4B is a block diagram illustrating an example of cross-model architecture 480 with gating controllers, in accordance with aspects of the present disclosure. In the example of FIG. 4B, various elements 420, 422, 434, 436a, and 438a are the same as described with respect to FIG. 4A. For brevity, description of the elements 420, 422, 434, 436a, and 438a of FIG. 4B are omitted. Additionally, for brevity, some of the components of FIG. 4A have been omitted from FIG. 4B. In the example of FIG. 4B, a skip-connection gate 482a, 482b, 484a, and 484b may be specified at the end of each stage t. To reduce computational cost, each skip-connection gate 482a, 482b, 484a, and 484b may be designed as a fully-connected layer. The gating effect may be obtained by activating an output of the fully-connected layer associated with each skip-connection gate 482a, 482b, 484a, and 484b. Each leaky gate 486 may be opened by setting the output of a corresponding skip-connection gate 482a, 482b, 484a, and 484b to approximately one, and each leaky gate 486 may be closed by setting the output of the corresponding skip-connection gate 482a, 482b, 484a, and 484b to approximately zero. A closed gate (not shown in FIG. 4B) may be an example of a leakage path. In this example, the features input to the closed gate may leak out with a small intensity. The leaking features may be an example of leaky features.

In the example of FIG. 4B, for the visual modality at stage one, a first skip-connection gate 482a receives the attention-weighted visual features (\hat{X}ᵥ⁽¹⁾) from the cross-correlation component 434 of stage one and yields a gating matrix. The gating matrix may be represented as Uᵥ⁽¹⁾∈ [symbol] ^{2×L}, where L represents a number of frames and the number 2 represents a binary value for a gate. In some examples, a binary output may be specified for each frame. In one configuration, each row of the gating matrix generated by the first skip-connection gate 482a may be expanded to a dᵥ×L-sized matrix. As discussed above, dᵥ represents a dimensional visual feature. The expanded matrices U_{v,0}⁽¹⁾ and U_{v,1}⁽¹⁾ may control an output of the leaky gate 486 associated with the first skip-connection gate 482a, such that the gated feature of stage one is:

Z_{att,v}⁽¹⁾=Xᵥ⊗U_{v,0}⁽¹⁾+\tilde{X}ᵥ⁽¹⁾⊗U_{v,0}⁽¹⁾. (12)

In Equation 12, ⊗ represents an element-wise multiplication. Additionally, in Equation 12, a value of approximately zero for either of the expanded matrices U_{v,0}⁽¹⁾ and U_{v,1}⁽¹⁾ closes the features input to the leaky gate 486 associated with the first skip-connection gate 482a. As discussed, the features input to the closed gate may leak out with a small intensity. Additionally, a value of approximately one for either of the expanded matrices U_{v,0}⁽¹⁾ and U_{v,1}⁽¹⁾ closes the features input to the leaky gate 486 associated with the first skip-connection gate 482a. In one example, the expanded matrices U_{v,0}⁽¹⁾ and U_{v,1}⁽¹⁾ may have respective values of zero and one, resulting in closing the attention-weighted visual features (\tilde{X}ᵥ⁽¹⁾) and opening the visual latent representation 432 (Xᵥ). In another example, the expanded matrices U_{v,0}⁽¹⁾ and U_{v,1}⁽¹⁾ may have respective values of one and zero, resulting in opening the attention-weighted visual features (\tilde{X}ᵥ⁽¹⁾) and closing the visual latent representation 432 (Xᵥ). In some examples, U_{v,0}⁽ⁱ⁾ and U_{v,1}⁽ⁱ⁾ may be based on respective rows of a gating matrix (Uᵥ⁽ⁱ⁾). As an example, first and second rows of the gating matrix may be retrieved, where each row represents a 1×L vector. In this example, each vector may be augmented to obtain a dᵥ×L-sized matrix. That is, each vector may be copied for a number of times equal to a value of dᵥ. Based on the described process, two different matrices, such as U_{v,0}⁽ⁱ⁾ and U_{v,1}⁽ⁱ⁾, may be associated with the respective vectors. The process for controlling the leaky gate 486 associated with a second skip-connection gate 484a associated with audio features is similar to the process discussed above for controlling the leaky gate 486 associated with the first skip-connection gate 482a.

As shown in FIG. 4B, a third skip-connection gate 482b at stage two may receive the attention-weighted visual features (Xᵥ⁽²⁾) from the cross-correlation component 434 of stage two and yields a gating matrix. For stage two, the gating matrix may be represented as Uᵥ⁽²⁾∈ [symbol] ^{3×L}. In this example, the gating matrix may be expanded to a dᵥ×L-sized matrix. The expanded matrices U_{v,0}⁽²⁾, U_{v,1}⁽²⁾, and U_{v,2}⁽²⁾ may control an output of the leaky gate 486 associated with the third skip-connection gate 482b, such that the gated feature of stage one is:

$${Z}_{att , v}^{( 2 )} = ( \begin{matrix}( {X}_{v} + {\tilde{X}}_{v}^{( 1 )} + {\tilde{X}}_{v}^{( 2 )} ) ⊗ {U}_{v , 0}^{( 2 )} + ( {X}_{v} + {\tilde{X}}_{v}^{( 2 )} ) ⊗ {U}_{v , 1}^{( 2 )} + \\ ( {X}_{att , v}^{( 1 )} + {X}_{att , v}^{( 2 )} ) ⊗ {U}_{v , 2}^{( 2 )}\end{matrix} ) . \qquad ( 13 )$$

In Equation 13, a value associated with each of the expanded matrices U_{v,0}⁽²⁾, U_{v,1}⁽²⁾, and U_{v,2}⁽²⁾ closes or opens the features input to the leaky gate 486 associated with the third skip-connection gate 482b. The process for controlling the leaky gate 486 associated with a fourth skip-connection gate 484b associated with audio features is similar to the process discussed above for controlling the leaky gate 486 associated with the third skip-connection gate 482b.

In addition to skip-connection gates 482a, 482b, 484a, and 484b, the cross-model architecture 480 with gating controllers may include stage gates 490 and 488 As an example, a first stage gate 490 may receive attention-weighted visual features of a last stage (\tilde{X}ᵥ^{(t}^{ₑ}⁾, where tₑ=2) as an input. The first stage gate 490 determines a stage gating matrix that may be represented as Uᵥ^{(s)}∈ [symbol] ^{2×L}. The stage gating matrix may be) expanded to a dᵥ×L-sized matrix. The expanded matrices U_{v,0}^{(s)} and U_{v,1}^{(s)} may control an output of the leaky gate 486 associated with the first stage gate 490, such that a final output for the visual localization may be determined based on the gating performed at the leaky gate 486 associated with the first stage gate 490. Specifically, the final output is:

Z_{att,v}=X_{att,v}⁽¹⁾⊗U_{v,0}^{(s)}+X_{att,v}⁽²⁾⊗U_{v,1}^{(s)} (14)

The process for controlling the leaky gate 486 associated with a second stage gate 488 is similar to the process discussed above for controlling the leaky gate 486 associated with the first stage gate 490. In some aspects of the present disclosure, a multi-modal feature may be obtained by concatenating the stage gated features (Z_{att,v} and Z_{att,u}), which may be represented as:

r(Zᵥ,Zᵤ)=[Z_{att,v};Z_{att,u}] (15)

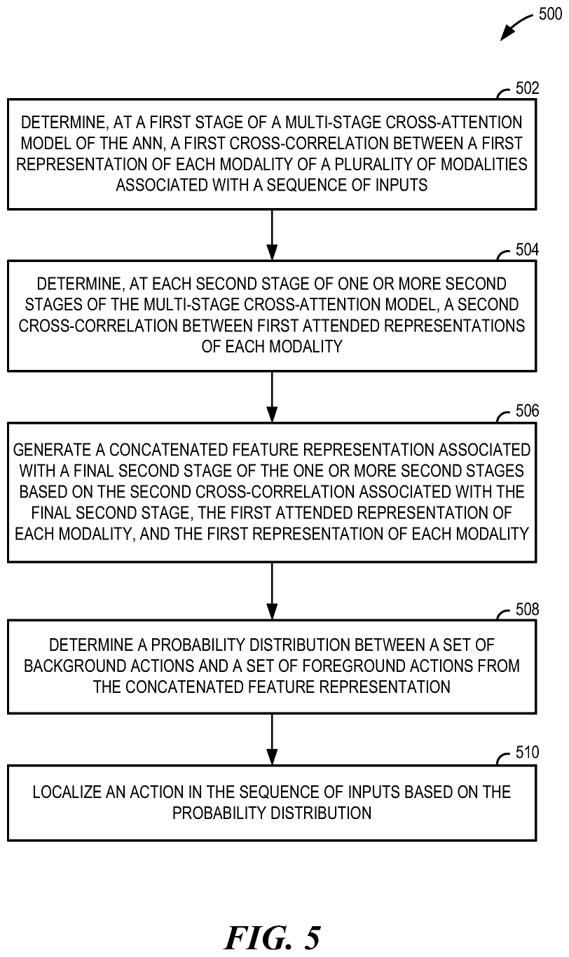

FIG. 5 illustrates a flow diagram for a method 500 according to an aspect of the present disclosure. The method 500 may be performed by an artificial neural network (ANN), such as the cross-model architecture 400 and 480 described in FIGS. 4A and 4B, respectively. As shown in FIG. 5, at block 502, the ANN, determines, at a first stage of a multi-stage cross-attention model of the ANN, a first cross-correlation between a first representation of each modality of a number of modalities associated with a sequence of inputs. In some examples, the first representation is a latent representation based on features of each modality extracted from the sequence of inputs. Additionally, the first modality may be a visual modality, the second modality may be an audio modality, and the sequence of inputs may be a sequence of frames of a video. The video may be captured by a camera, or another sensor, associated with the ANN. As an example, the camera may be integrated with a vehicle that implements the ANN. Aspects of the present disclosure also contemplate correlating other types of modalities received from one or more sensor data streams, such as, but not limited to LIDAR, RADAR, motion, or gyroscopic.

At block 504, the ANN determines, at each second stage of one or more second stages of the multi-stage cross-attention model, a second cross-correlation between first attended representations of each modality. In some examples, a first attended representation of a first modality of the number of modalities may be based on the first cross-correlation and the first representation of the first modality. Additionally, the first attended representation of a second modality of the number of modalities may be based on the first cross-correlation and the first representation of the second modality. At block 506, the ANN generates a concatenated feature representation associated with a final second stage of the one or more second stages based on the second cross-correlation associated with the final second stage, the first attended representation of each modality, and the first representation of each modality. The final second stage may be an example of a final stage of the multi-stage cross-attention model, such as the second stage of the multi-stage cross-attention component 402 described with reference to FIG. 4A. At block 508, the ANN determines a probability distribution between a set of background actions and a set of foreground actions from the concatenated feature representation. The probability distribution may be determined based on Equation 8. At block 510, the ANN localizes an action in the sequence of inputs based on the probability distribution.

Implementation examples are described in the following numbered clauses.
1. A method performed by an artificial neural network (ANN), comprising:
determining, at a first stage of a multi-stage cross-attention model of the ANN, a first cross-correlation between a first representation of each modality of a plurality of modalities associated with a sequence of inputs;
determining, at each second stage of one or more second stages of the multi-stage cross-attention model, a second cross-correlation between first attended representations of each modality,
a first attended representation of a first modality of the plurality of modalities based on the first cross-correlation and the first representation of the first modality, and
the first attended representation of a second modality of the plurality of modalities based on the first cross-correlation and the first representation of the second modality;
generating a concatenated feature representation associated with a final second stage of the one or more second stages based on the second cross-correlation associated with the final second stage, the first attended representation of each modality, and the first representation of each modality;
determining a probability distribution between a set of background actions and a set of foreground actions from the concatenated feature representation; and
localizing an action in the sequence of inputs based on the probability distribution.
2. The method of Clause 1, in which the first representation is a latent representation based on features of each modality extracted from the sequence of inputs.
3. The method of any one of Clauses 1-2, further comprising:
generating the first attended representation of the first modality based on a sum of the first cross-correlation and the first representation of the first modality; and
generating the first attended representation of the second modality based on a sum of the first cross-correlation and the first representation of the second modality.
4. The method of Clause 3, further comprising determining the second cross-correlation based on a product of the first attended representation of each modality and a weight variable.
5. The method of any one of Clauses 1-4, further comprising generating a second attended representation of each modality based on a sum of the at least one second cross-correlation and the first attended representation of each modality.
6. The method of Clause 5, further comprising generating the concatenated feature representation based on the second attended representation of each modality.
7. The method of any one of Clauses 1-6, in which determining the probability distribution comprises:
determining a reliability of a prediction of each foreground action of the set of foreground actions; and
determining a reliability of a prediction of each background action of the set of background actions as a function of the foreground action at each input.
8. The method of any one of Clauses 1-7, in which:
the first modality is a visual modality;
the second modality is an audio modality; and
the sequence of inputs is a sequence of frames.
9. The method of any one of Clauses 1-8, the method further comprises gating each skip-connection of a plurality of skip-connections, in which:
each stage of the multi-stage cross-attention model is associated with a pair of skip-connections of the plurality of skip-connections; and
each skip-connection of the pair of skip-connections is associated with one modality of the plurality of modalities.
10. The method of Clause 9, further comprising gating each skip-connection based on an output of a gating layer associated with the respective stage of the multi-stage cross-attention model associated with the respective skip-connection.
11. The method of Clause 9, in which each skip connection outputs a stage gated feature a plurality of stage gated features, each stage gated feature associated with one modality of the plurality of modalities.
12. The method of Clause 9, in which the method further comprises gating each stage-connection of a plurality of stage-connections, in which:
each stage-connection of the plurality of stage-connections receives an input from a set of skip-connections, each skip-connection of the set of skip-connections associated with a different stage of the multi-stage cross-attention model, and each skip-connection of the set of skip-connections being one skip-connection of the plurality of skip-connections.
13. The method of Clause 12, in which:
each stage each stage-connection of the plurality of stage-connections is gated based on final attended representation of one modality of the plurality of modalities; and
the final attended representation of each modality of the plurality of modalities being determined at a final stage of the multi-stage cross-attention model.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described here may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method performed by an artificial neural network (ANN), comprising:
determining, at a first stage of a multi-stage cross-attention model of the ANN, a first cross-correlation between a first representation of each modality of a plurality of modalities associated with a sequence of inputs;
determining, at each second stage of one or more second stages of the multi-stage cross-attention model, a second cross-correlation between first attended representations of each modality,
a first attended representation of a first modality of the plurality of modalities based on the first cross-correlation and the first representation of the first modality, and
the first attended representation of a second modality of the plurality of modalities based on the first cross-correlation and the first representation of the second modality;
generating a concatenated feature representation associated with a final second stage of the one or more second stages based on the second cross-correlation associated with the final second stage, the first attended representation of each modality, and the first representation of each modality;
determining a probability distribution between a set of background actions and a set of foreground actions from the concatenated feature representation; and
localizing an action in the sequence of inputs based on the probability distribution.

2. The method of claim 1, in which the first representation is a latent representation based on features of each modality extracted from the sequence of inputs.

3. The method of claim 1, further comprising:
generating the first attended representation of the first modality based on a sum of the first cross-correlation and the first representation of the first modality; and
generating the first attended representation of the second modality based on a sum of the first cross-correlation and the first representation of the second modality.

4. The method of claim 3, further comprising determining the second cross-correlation based on a product of the first attended representation of each modality and a weight variable.

5. The method of claim 1, further comprising generating a second attended representation of each modality based on a sum of the at least one second cross-correlation and the first attended representation of each modality.

6. The method of claim 5, further comprising generating the concatenated feature representation based on the second attended representation of each modality.

7. The method of claim 1, in which determining the probability distribution comprises:
determining a reliability of a prediction of each foreground action of the set of foreground actions; and
determining a reliability of a prediction of each background action of the set of background actions as a function of the foreground action at each input.

8. The method of claim 1, in which:
the first modality is a visual modality;
the second modality is an audio modality; and
the sequence of inputs is a sequence of frames.

9. The method of claim 1, further comprising gating each skip-connection of a plurality of skip-connections, in which:
each stage of the multi-stage cross-attention model is associated with a pair of skip-connections of the plurality of skip-connections; and
each skip-connection of the pair of skip-connections is associated with one modality of the plurality of modalities.

10. The method of claim 9, further comprising gating each skip-connection based on an output of a gating layer associated with the respective stage of the multi-stage cross-attention model associated with the respective skip-connection.

11. The method of claim 9, in which each skip connection outputs a stage gated feature a plurality of stage gated features, each stage gated feature associated with one modality of the plurality of modalities.

12. The method of claim 9, further comprising gating each stage-connection of a plurality of stage-connections, in which:
each stage-connection of the plurality of stage-connections receives an input from a set of skip-connections, each skip-connection of the set of skip-connections associated with a different stage of the multi-stage cross-attention model, and each skip-connection of the set of skip-connections being one skip-connection of the plurality of skip-connections.

13. The method of claim 12, in which:
each stage each stage-connection of the plurality of stage-connections is gated based on final attended representation of one modality of the plurality of modalities; and
the final attended representation of each modality of the plurality of modalities being determined at a final stage of the multi-stage cross-attention model.

14. An artificial neural network (ANN), comprising:
a processor;
a memory coupled with the processor; and
instructions stored in the memory and operable, when executed by the processor, to cause the ANN:
to determine, at a first stage of a multi-stage cross-attention model of the ANN, a first cross-correlation between a first representation of each modality of a plurality of modalities associated with a sequence of inputs;
to determine, at each second stage of one or more second stages of the multi-stage cross-attention model, a second cross-correlation between first attended representations of each modality, a first attended representation of a first modality of the plurality of modalities based on the first cross-correlation and the first representation of the first modality, and the first attended representation of a second modality of the plurality of modalities based on the first cross-correlation and the first representation of the second modality;
to generate a concatenated feature representation associated with a final second stage of the one or more second stages based on the second cross-correlation associated with the final second stage, the first attended representation of each modality, and the first representation of each modality;
to determine a probability distribution between a set of background actions and a set of foreground actions from the concatenated feature representation; and
to localize an action in the sequence of inputs based on the probability distribution.

15. The ANN of claim 14, in which the first representation is a latent representation based on features of each modality extracted from the sequence of inputs.

16. The ANN of claim 14, in which execution of the instructions further cause the apparatus:
to generate the first attended representation of the first modality based on a sum of the first cross-correlation and the first representation of the first modality; and
to generate the first attended representation of the second modality based on a sum of the first cross-correlation and the first representation of the second modality.

17. The ANN of claim 16, in which execution of the instructions further cause the apparatus to determine the second cross-correlation based on a product of the first attended representation of each modality and a weight variable.

18. The ANN of claim 14, in which execution of the instructions further cause the apparatus to generate a second attended representation of each modality based on a sum of the at least one second cross-correlation and the first attended representation of each modality.

19. The ANN of claim 18, in which execution of the instructions further cause the apparatus to generate the concatenated feature representation based on the second attended representation of each modality.

20. The ANN of claim 14, in which execution of the instructions to determine the probability distribution further cause the apparatus:
to determine a reliability of a prediction of each foreground action of the set of foreground actions; and
to determine a reliability of a prediction of each background action of the set of background actions as a function of the foreground action at each input.

21. The ANN of claim 14, in which:
the first modality is a visual modality;
the second modality is an audio modality; and
the sequence of inputs is a sequence of frames.

22. The ANN of claim 14, in which execution of the instructions further cause the apparatus to gate each skip-connection of a plurality of skip-connections, in which:
each stage of the multi-stage cross-attention model is associated with a pair of skip-connections of the plurality of skip-connections; and
each skip-connection of the pair of skip-connections is associated with one modality of the plurality of modalities.

23. The ANN of claim 22, in which execution of the instructions further cause the apparatus to gate each skip-connection based on an output of a gating layer associated with the respective stage of the multi-stage cross-attention model associated with the respective skip-connection.

24. The ANN of claim 22, in which each skip connection outputs a stage gated feature a plurality of stage gated features, each stage gated feature associated with one modality of the plurality of modalities.

25. The ANN of claim 22, in which execution of the instructions further cause the apparatus to gate each stage-connection of a plurality of stage-connections, in which:
each stage-connection of the plurality of stage-connections receives an input from a set of skip-connections, each skip-connection of the set of skip-connections associated with a different stage of the multi-stage cross-attention model, and each skip-connection of the set of skip-connections being one skip-connection of the plurality of skip-connections.

26. The ANN of claim 25, in which:
each stage each stage-connection of the plurality of stage-connections is gated based on final attended representation of one modality of the plurality of modalities; and
the final attended representation of each modality of the plurality of modalities being determined at a final stage of the multi-stage cross-attention model.

27. A non-transitory computer-readable medium having program code recorded thereon for an artificial neural network (ANN), the program code executed by a processor and comprising:
program code to determine, at a first stage of a multi-stage cross-attention model of the ANN, a first cross-correlation between a first representation of each modality of a plurality of modalities associated with a sequence of inputs;
program code to determine, at each second stage of one or more second stages of the multi-stage cross-attention model, a second cross-correlation between first attended representations of each modality, a first attended representation of a first modality of the plurality of modalities based on the first cross-correlation and the first representation of the first modality, and the first attended representation of a second modality of the plurality of modalities based on the first cross-correlation and the first representation of the second modality;
program code to generate a concatenated feature representation associated with a final second stage of the one or more second stages based on the second cross-correlation associated with the final second stage, the first attended representation of each modality, and the first representation of each modality;
program code to determine a probability distribution between a set of background actions and a set of foreground actions from the concatenated feature representation; and
program code to localize an action in the sequence of inputs based on the probability distribution.

28. The non-transitory computer-readable medium of claim 27, in which:
the first modality is a visual modality;
the second modality is an audio modality; and
the sequence of inputs is a sequence of frames.

29. An artificial neural network (ANN), comprising:
means for determining, at a first stage of a multi-stage cross-attention model of the ANN, a first cross-correlation between a first representation of each modality of a plurality of modalities associated with a sequence of inputs;
means for determining, at each second stage of one or more second stages of the multi-stage cross-attention model, a second cross-correlation between first attended representations of each modality,
a first attended representation of a first modality of the plurality of modalities based on the first cross-correlation and the first representation of the first modality, and
the first attended representation of a second modality of the plurality of modalities based on the first cross-correlation and the first representation of the second modality;
means for generating a concatenated feature representation associated with a final second stage of the one or more second stages based on the second cross-correlation associated with the final second stage, the first attended representation of each modality, and the first representation of each modality;
means for determining a probability distribution between a set of background actions and a set of foreground actions from the concatenated feature representation; and
means for localizing an action in the sequence of inputs based on the probability distribution.

30. The ANN of claim 29, in which:
the first modality is a visual modality;
the second modality is an audio modality; and
the sequence of inputs is a sequence of frames.
